(19) United States
(12) Patent Application Publication
(10) Pub. No.: US 2006/0208466 A1
(43) Pub. Date: Sep. 21, 2006

(54) Curtain airbag bottom fill

(75) Inventor: Jesse B. Kirby, Bloomfield Hills, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/083,308

(22) Filed: Mar. 18, 2005

(51) Int. Cl. B60R 21/22; B60R 21/26

(52) U.S. Cl. 280/730.2; 280/742

(57) ABSTRACT

A bottom fill airbag that is adapted so that inflation gas is channeled to the bottom of the airbag, causing the bottom portion of the airbag to initially inflate, then subsequently and progressively filling the entire airbag chambers from the lower portions upward to the top of the airbag. The bottom fill side airbag may include one or a plurality of channels that direct inflation gas from an inflator down to lower portions of the airbag. The inflation gas subsequently and progressively fills airbag chambers, starting from the bottom of the airbag and moving upwards inside of the airbag.

### BACKGROUND

The present invention relates to a protective, bottom filled side airbag for protection of a vehicle occupant's head and, more particularly, to an airbag which is to be inflated to expand over windows of side doors in the event of a lateral collision or roll-over of a vehicle.

An airbag for the protection of a vehicle occupant's head may be disposed along a corner formed by a roof and a side portion of a vehicle cabin in the normal state and is adapted to be inflated with gas introduced through gas inlets to expand over windows of side doors.

Most of such head protective airbags are of a type which is disposed from an A-pillar along a roof side rail. Among the head protective airbags, there is a type not to allow the inflation of a portion along the A-pillar and a type to allow the inflation of a portion along the A-pillar. The present invention relates to a head protective airbag of a type to allow a portion along the A-pillar to be inflated just like the latter type and to a head protective airbag device with the head protective airbag.

In a conventional head protective airbag which is adapted to allow the inflation of a portion along a pillar, the airbag starts to be inflated within the cover and pushes and opens the cover, whereby the airbag deploys into the vehicle cabin. Therefore, the cover must have a large enough opening to allow the deployment of the already expanding airbag.

The present invention relates to a bottom filled side airbag for protecting vehicle occupants during collisions and rollover accidents.

In a conventional side airbag, the airbag is typically deployed from the headliner of a vehicle. The airbag, or cushion, is typically rolled and/or folded into a compact package that is stored in the headliner area. The airbag is pressurized during deployment and forced out of the containment area into an operating position. In conventional designs, the inflator typically directs an inflation gas directly into upper sections of the airbag, thereby filling the cushion from the top down.

This fill process pushes the airbag down into an operating position. This design tends to deploy from headliners and present a large volume envelope that descends downward along the interior side or interior surface of the vehicle until the airbag is fully inflated. If an occupant's head is near, or in contact with, the vehicle interior surface or structure, the large volume of the deploying airbag will seek to occupy the same position and in effect push downward on the occupant's head during deployment.

### SUMMARY

It is an object of the present invention to provide a head protective airbag which is adapted to allow the inflation of a portion along a pillar, but not to allow or scarcely allow the inflation before it is pulled or dragged out of a pillar cover, whereby the portion can be extremely smoothly dragged out of the pillar cover and to provide a head protective airbag device provided with the airbag.

According to an embodiment of the present invention, a head protective airbag is a head protective airbag to be disposed to extend along at least one pillar and a roof side rail, comprising one or more first cell extending along the pillar, and one or more second cell extending along the roof side rail, wherein a passage for introducing gas into the first cell is connected to the first cell only at a portion opposite to the pillar side of the first cell.

In addition, a head protective airbag device of the present invention may include the above head protective airbag and a gas supply device for supplying gas into the head protective airbag.

According to an embodiment of the present invention, a head protective airbag and airbag device has gas introduced into the airbag to inflate the airbag, wherein introduction of gas into a first cell extending along a pillar is conducted only through a gas passage connected to the portion opposite to the pillar side of the first cell. In this case, the gas passage is inflated with gas prior to the inflation of the first cell. Until the gas passage is inflated, the airbag pushes and opens a cover so as to start to deploy into a vehicle cabin. Therefore, the first cell is pulled by a portion that includes the inflated gas passage, whereby the first cell opens the pillar cover and is pulled out into the vehicle cabin before the first cell starts to be inflated or the cells are inflated a little. Because the first cell which is not or scarcely inflated is still small in volume, the first cell can be smoothly pulled out with little interference with the pillar cover. Then, the first cell coming out of the cover can be smoothly inflated with introduced gas without any restraint by the pillar cover.

The gas passage preferably includes a first gas passage extending substantially vertically from an upper portion to a lower portion of the head protective airbag, and a second gas passage extending along the lower side of the head protective airbag and connecting the first gas passage to the first cell.

According to an embodiment of the invention, after the first gas passage extending vertically is inflated to deploy downwardly, a second gas passage is inflated whereby the first cell is dragged out of the pillar cover. In this case, it is preferable that the at least one second cell is disposed along the first gas passage. According to this head protective airbag, when the first gas passage of the airbag is inflated to deploy downwardly, the second cell is pulled downwardly by the inflated first gas passage. Therefore, the second cell can be smoothly inflated.

According to an embodiment of the present invention, the first cell may be formed substantially in a triangular profile of which one side extends along the pillar and the gas passage is connected to a portion including an opposing corner of the one side of the triangular profile. Because the triangular first cell starts to come out of the pillar cover at an apex (the aforementioned corner) of the triangular profile, the resistance applied to the first cell by the pillar cover is extremely small.

It is an object of the present invention to provide a bottom filled side airbag that is designed to deploy a thinner, non-fully inflated airbag down into a fully extended position prior to a final filling of the airbag chambers. An airbag operating in this manner may reduce excessive, undesirable contact with an occupant during deployment when the occupant is near, or in contact with, the interior surface or structure of a vehicle. This airbag may reduce the time for the airbag to deploy into its operating position, provide a thinner volume during the initial stages of deployment, and reduce the total air bag volume. It is an object of the present invention to provide a side airbag module using this side airbag.

According to an embodiment of the present invention, a side curtain airbag for protecting an occupant of a vehicle, is provided that includes at least one fill channel, wherein the fill channel is adapted to channel inflation gas from a top portion of the airbag to a bottom portion of the airbag, causing the bottom portion of the airbag to initially inflate, then subsequently and progressively fill airbag chambers from lower portions of the airbag upward to a top of the airbag, where the airbag is configured so that all the inflation gas passes through the fill channel.

According to an embodiment of the present invention, a bottom fill airbag for the side of a vehicle is provided that includes at least one fill channel, wherein the fill channel is adapted to channel all inflation gas from an inflator directly to a bottom portion of the airbag, causing the bottom portion of the airbag to initially inflate, then subsequently and progressively fill airbag chambers from lower portions of the airbag upward to a top of the airbag.

In an embodiment of the present invention, a side airbag module for protecting the occupant of a vehicle is provided that includes an inflator and an airbag that includes at least one fill channel, wherein the fill channel is adapted to channel all inflation gas to a bottom portion of the airbag, causing the bottom portion of the airbag to initially inflate, then subsequently and progressively fill airbag chambers from lower portions of the airbag upward to a top of the airbag.

According to an embodiment of the present invention, a side curtain airbag for protecting an occupant of a vehicle is provided that includes an airbag with at least one inflation chamber and at least one fill channel for carrying inflation gas to at least one inflation chamber, wherein the ratio of the volume of the fill channel to the total inflatable volume of the airbag is less than 0.2.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a front view, as seen from a vehicle cabin, showing a head protective airbag according an embodiment of the present invention.

FIG. 2 is an illustration showing a deployment process of the head protective airbag.

FIG. 3 is an illustration showing a deployment process of the head protective airbag.

FIG. 4 is an illustration showing a deployment process of the head protective airbag.

FIG. 5 is a front view, as seen from a vehicle cabin, showing a head protective airbag according another embodiment.

FIG. 6 is a side view of a bottom fill side airbag according to an embodiment of the present invention.

FIG. 7 is a side view of a bottom fill side airbag in a deployed state according to an embodiment of the present invention.

FIG. 8 is a side view of a bottom fill side airbag with multiple fill channels according to an embodiment of the present invention.

FIG. 9 is a side view of a bottom fill side airbag according to an embodiment of the present invention.

### DETAILED DESCRIPTION

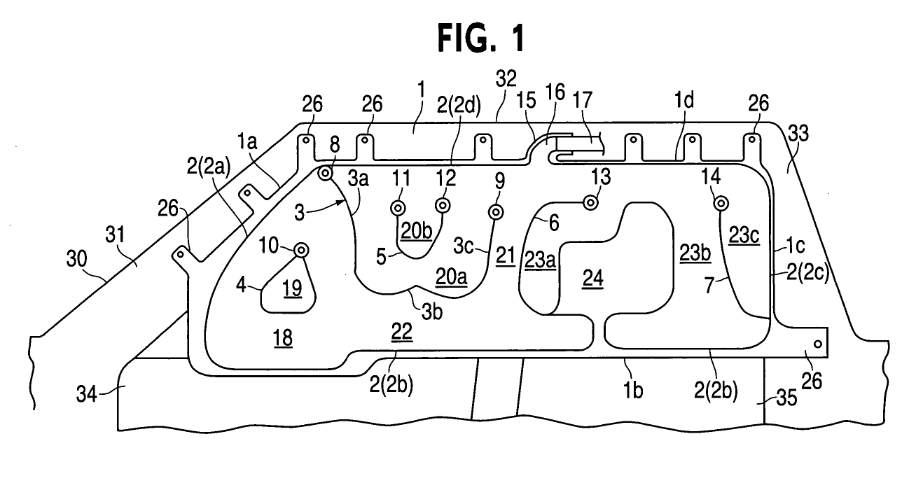

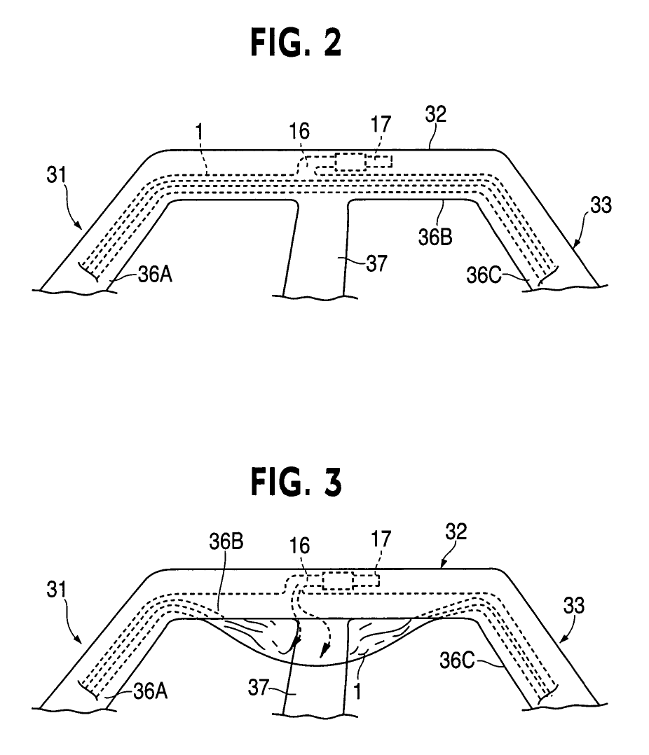

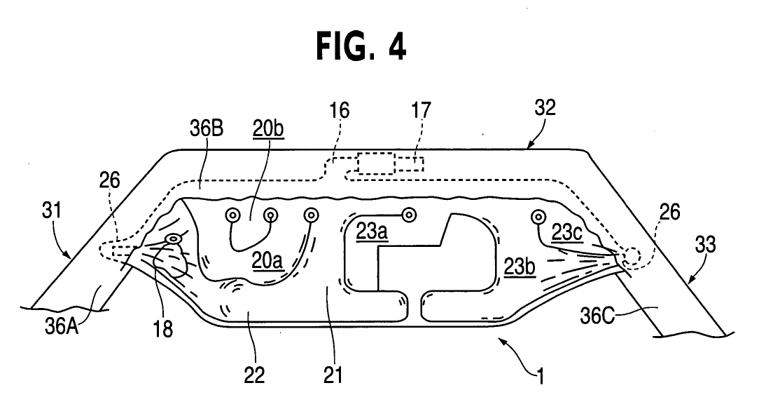

Hereinafter, embodiments of the present invention will be described with reference to the attached drawings. FIG. 1 is a front view, as seen from a vehicle cabin, showing a head protective airbag according an embodiment of the present invention and FIGS. 2-4 are illustrations showing deployment processes of the head protective airbag. In the following description, the longitudinal direction is the longitudinal (back-and-forth) direction of a vehicle to which the head protective airbag is installed.

A head protective airbag 1 of this embodiment is folded and disposed to extend from an A-pillar 31 to a B-pillar 33 through a roof side rail 32 of a vehicle 30. The airbag 1 has substantially a trapezoidal profile in the deployment state so that it is inflated into a curtain shape to extend along a side surface of the vehicle cabin from the roof side rail 32 and the respective pillars 31, 33 to the vicinity of the upper edges of front and rear door panels 34, 35 so as to cover over the upper half of a side face of the vehicle cabin in the event of a lateral collision or roll-over of a vehicle.

That is, the airbag 1 has a front side 1a to be extending along the A-pillar 31, a lower side 1b to be extending along the upper edges of the door panels 34, 35, a rear side 1c to be extending along the B-pillar 33, and an upper side 1d to be extending along the roof side rail 32 wherein the lower side 1b is longer than the upper edge 1d so that the airbag 1 substantially has a trapezoidal profile.

The airbag 1 comprises two sheets which are joined to each other by joints including a line-shaped joint 2 extending around their peripheries (with some parts thereof extending inward of the sheets), line-shaped joints 3-7 extending inside the peripheries, and circular joints 8-14 for reinforcing areas around ends of the line-shaped joints 3-7. The airbag 1 is designed to be inflated by introduction of gas into spaces between the sheets. It should be noted that the line-shaped joints 2-7 and the circular joints 8-14 may be formed by any of various joining processes such as sewing, bonding, and welding.

The airbag 1 has an L-shaped projection 15 extending from a middle portion in the longitudinal direction of the upper side Id thereof. Formed in the projection 15 is a gas inlet 16 for introducing gas into the airbag 1. A gas generator (inflator) 17 is connected to the gas inlet 16 for inflating the airbag 1. In an alternative embodiment, the projection 15 may be a separate piece from the airbag 1.

The line-shaped joint 2 comprises a front part 2a extending along the front side 1a, a lower part 2b extending along the lower side 1b, a rear part 2c extending along the rear side 1c, and an upper part 2d extending along the upper side 1d of the airbag 1.

The line-shaped joint 3 extends to communicate with a circular joint 8 which is disposed near a corner formed by the front side 1a and the upper side 1d of the airbag 1. The circular joint 8 is positioned to border on or quite close to the line-shaped joint 2 at the corner.

The line-shaped joint 3 is formed in a U-like shape comprising a front part 3a extending diagonally from the circular joint 8 to the lower back of the airbag 1, a middle part 3b as a continuation of the front part 3a and extending substantially in the longitudinal direction at about the middle in the vertical direction of the airbag 1, and a rear part 3c extending from the middle part 3b toward a middle portion in the longitudinal direction of the upper side 1d of the airbag and connected to a circular joint 9.

The middle part 3b of the line-shaped joint 3 is spaced apart from the line-shaped joint 2 extending along the lower side 1c of the airbag, thereby forming a second gas passage 22 between the line-shaped joint 2 and the middle part 3b of the line-shaped joint 3. The second gas passage 22 extends in the longitudinal direction along the lower part 2b of the line-shaped joint 2 in a lower portion of the airbag 1.

A first cell 18 formed substantially in a triangular profile is defined by the front part 3a of the line-shaped joint 3 extending diagonally to the lower back, a front-side portion of the lower part 2b of the line-shaped joint 2 extending in the longitudinal direction, and the front part 2a of the line-shaped joint 2 extending along the A-pillar 31. The triangular first cell 18 communicates with the second gas passage 22 at an opposing corner of the front part 2a of the line-shaped joint of the first cell 18, that is, at a corner between the rear side and the lower side of the first cell 18.

Inside the first cell 18, a line-shaped joint 4 formed substantially in a triangular profile which is similar to and smaller than the figure of the first cell 18 is formed. An inside area 19 defined by the line-shaped joint 4 is a non-inflatable portion into which no gas is introduced. The non-inflatable portion acts to prevent the thickness of the airbag when inflated from being too large. The line-shaped joint 4 extends in a loop starting from a circular joint 10 and returning to the circular joint 10.

Formed between the rear part 3c of the line-shaped joint 3 and a line-shaped joint 6 is a first gas passage 21. The upper portion of the first gas passage 21 faces the aforementioned gas inlet 16 and the lower portion of the first gas passage 21 communicates with the second gas passage 22. The first gas passage 21 extends in the vertical direction at a middle portion in the longitudinal direction of the airbag 1.

A second cell 20a is defined along the front-side of the first gas passage 21. The second cell 20a is formed in a U-like shape between the line-shaped joint 3 and the line-shaped joint 5. In this embodiment, two circular joints 11 and 12 are formed at substantially the same level (height) with of the circular joint 9 in front of the circular joint 9. The line-shaped joint 5 is formed to extend in a U-like shape between the circular joints 11 and 12.

A line-shaped joint 6 is formed substantially in a C-like shape as a continuation of the lower part 2b of the line-shaped joint 2, extending upwardly at a middle portion in the longitudinal direction of the airbag 1, and being curved rearwardly toward a circular joint 13.

The lower part 2b of the line-shaped joint 2 extends substantially into a Ω-like shape between a middle portion and a rear portion of the airbag 1 and returns to the vicinity of the lower side 1b of the airbag 1. An area 24 defined and surrounded by the lower part 2b of the line-shaped joint 2 in the Ω-like shape is a non-inflatable portion into which no gas is introduced. A cell 23a is formed between this area 24 and the first gas passage 21, a cell 23b is formed between this area 24 and a line-shaped joint 7, and a cell 23c is formed between the line-shaped joint 7 and the rear part 2c of the line-shaped joint 2.

The line-shaped joint 7 branches from a portion near the lower end of the rear part 2c of the line-shaped joint 2 and extends upwardly to reach a circular joint 14.

The circular joints 11, 12, 9, 13, 14 may be positioned substantially at the same level (height), thereby forming a narrow gas passage, extending along the upper side 1d of the airbag 1, between these circular joints 11, 12, 9, 13, 14 and the upper part 2d of the line-shaped joint 2.

The airbag 1 may be folded by pulling the lower edge thereof up and is disposed along about the roof side rail 32, the A-pillar 31, and the C-pillar 33. In a storage position, the airbag 1 may be covered by a suitable cover such as a pillar trim and a roof trim (not shown).

The airbag 1 having the aforementioned structure acts as follows. When the vehicle is involved in a lateral collision or roll-over, the inflator 17 is activated to supply gas into the airbag 1. The gas from the inflator 17 flows through the gas inlet 16 mainly to the first gas passage 21 so as to inflate the middle portion in the longitudinal direction of the airbag 1 downwardly as shown in FIG. 3. Then, the airbag 1 pushes and open a roof trim 36B above a B-pillar 37 and thus starts to deploy into the vehicle cabin.

After the middle portion of the airbag 1 further deploys along the B-pillar from the state shown in FIG. 3, gas flows into the second gas passage 22 so that the lower edge portion of the airbag 1 is also inflated. At the time when the second gas passage 22 starts to be inflated, a portion about the first cell 18 of the airbag 1 is pulled or dragged by already-inflated portions of the airbag 1, i.e. the second gas passage 22 and the area around the second gas passage 22, so as to tear a trim 36A of the A-pillar and come out of the trim 36. Gas from the second gas passage 22 is introduced into the first cell 18 thus pulled out, thereby inflating the first cell 18.

As described above, according to one embodiment of the present invention, the inflation of the first cell 18 is carried out after the first cell 18 is dragged out of the trim 36. When the first cell 18 comes out of the A-pillar trim 36A, the first cell 18 is not or scarcely inflated so that the first cell 18 is still small in volume. Accordingly, the frictional resistance applied to the first cell 18 by the A-pillar trim 36A is extremely small so that the first cell 18 can be extremely smoothly dragged out of the trim 36A. In addition, the trim 36A is required to create a smaller slit through which the airbag 1 is pulled out so that the trim 36A has a simple structure.

In this embodiment, the first cell 18 has a triangular profile of which one side extends along the A-pillar 31 and communicates with the second gas passage 22 at an opposing corner of the side along the A-pillar 31. When the second gas passage 22 is inflated, the first cell 18 starts to come out of the trim 36A at the corner side thereof. Therefore, the resistance applied to the first cell 18 by the trim 36A when the first cell 18 is dragged out of the trim 36A is extremely small, thereby allowing smooth deployment of the first cell 18.

When gas flows into the first gas passage 21 so that the middle portion of the airbag 1 is inflated downwardly as shown in FIG. 3, the first cell 20a and the cell 23a adjacent to the first gas passage 21 are also pulled by the inflated first gas passage 21 and is thus dragged out of the trim 36B. Because these cells 20a, 23a are inflated mainly outside the trim 36B, the movement of the airbag 1 pushing and opening the trim 36B to deploy out of the trim 36B is also smooth.

In this embodiment, because the cells 23b and 23c are also pulled by the first gas passage 21 which is already inflated or being inflated, the cells 23b and 23c are dragged out of the trims 36B, 36C into the vehicle cabin before the cells start to be inflated or the cells are inflated a little. The movement of these cells is also smooth.

Though the triangular first cell 18 is provided only in a front portion of the airbag 1 along the A-pillar 31 in the aforementioned embodiment, a triangular first cell may also be provided in a rear portion of the airbag along the C-pillar 33.

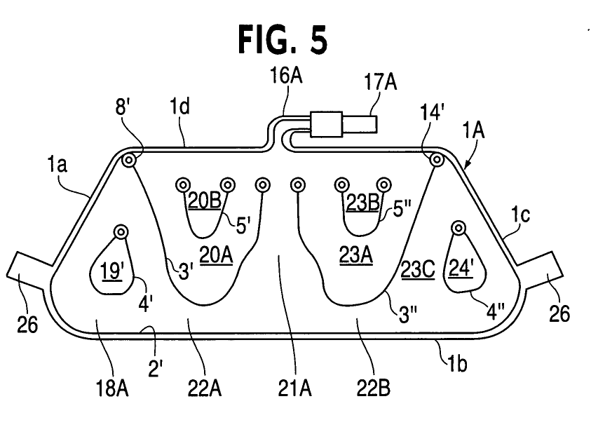

FIG. 5 shows an airbag 1 A according to another embodiment having such a structure. The airbag 1 A has triangular cells 18A, 23C formed in a front portion and a rear portion thereof. At the centers of the cells 18A, 23C, triangular non-inflatable areas 19′, 24′ are formed by line-shaped joints 4′, 4″, respectively. The cells 18A, 23C are defined by line-shaped joints 3′, 3″, respectively. The line-shaped joints 3′, 3″ are connected to circular joints 8′, 14′ formed at front and rear corners of the upper side of the airbag, respectively. A first gas passage 21 A is formed between the liner-shaped joints 3′and 3″. Formed between the line-shaped joints 3′, 3″ and a lower part of a line-shaped joint 2′ extending along the periphery of the airbag are second and third gas passages 22A, 22B which communicate with the first gas passage 21A and extend in the longitudinal direction.

The line-shaped joints 3′, 3″ are formed in U-like shape. Formed inside the U-like line-shaped joints 3′, 3″ are U-like line-shaped joints 5′, 5″, respectively. Second cells 20A, 23A are formed between the line-shaped joints 3′, 3″ and the line-shaped joints 5′, 5″, respectively.

Further, formed inside the line-shaped joints 5′, 5″ are cells 20B, 23B. The airbag 1A is connected at a front end and a rear end thereof to the A-pillar and the C-pillar via projections 26.

Also in this embodiment, gas from an inflator 17A introduced through a gas inlet 16A positioned substantially at a middle portion in the longitudinal direction of the airbag and flows into the first gas passage 21 A to start the inflation of the airbag 1A as shown in FIG. 3 and to quickly draw out the first cells 18A, 23C from trims of the A-pillar and the B-pillar. Because the cells 18A, 23C are not or scarcely inflated when pulled out, the cells 18A, 23C can be smoothly pulled out through small slits of the trims.

The above embodiments are both illustrative examples of the present invention and the present invention is not limited to the above embodiments. For example, the profile and location of the second cell may be changed. Even the profile of the first cell is not limited to triangle and may be substantially trapezoid, semi-circle, or square.

Though the line-shaped joint having a shape similar to and smaller than the first cell is provided inside the first cell and the area inside the line-shaped joint is non-inflatable portion in the above embodiments, the shape of the line-shaped joint is not limited to the shape similar to the first cell. Moreover, the non-inflatable portion may be omitted.

Though the circular joints are provided at ends of the line-shaped joints for reinforcing areas around ends of the line-shaped joints defining the first and second cells and the first and second gas passages, the circular joints may be omitted by connecting an end of a line-shaped joint to a midway of another line-shaped joint and by connecting ends of line-shaped joints.

Though the first gas passage is disposed substantially at the middle in the longitudinal direction of the airbag in the above embodiments, the location of the first gas passage is not limited thereto. Further, two first gas passages may be provided to be disposed at difference locations in the longitudinal direction of the airbag. In this case, it is preferable that the airbag is provided along the upper side of the airbag with a gas distributing means such as a duct having gas ports which are in communication with upper parts of the respective first gas passages.

Though the gas inlet is disposed substantially at the middle in the longitudinal direction of the upper side of the airbag in the above embodiments, the location of the gas inlet is not limited thereto. The inflator to be connected to the gas inlet may be located at any place such as the roof side rail or the C-pillar of the vehicle. When the inflator is located in the C-pillar, a duct for introduction of gas may be connected to the inflator in order to introduce gas from the inflator into the first gas passage.

Though the head protective airbag is fabricated by joining two sheets together in the above embodiments, the fabrication of the airbag is not limited thereto. For example, the airbag may be obtained by using a base fabric which is woven originally into an envelope shape by a so-called “hollow weaving” or “jacquard weaving” method. In this case, the first and second cells and the first and second gas passages are formed inside the airbag by woven joints inside and along the periphery of the airbag, instead of joining the opposite surfaces of the airbag by the line-shaped joints to divide the inside of the airbag.

As described above, according to the present invention, a head protective airbag can be smoothly dragged out of interior members such as trims when a gas generator of a head protective airbag device is actuated.

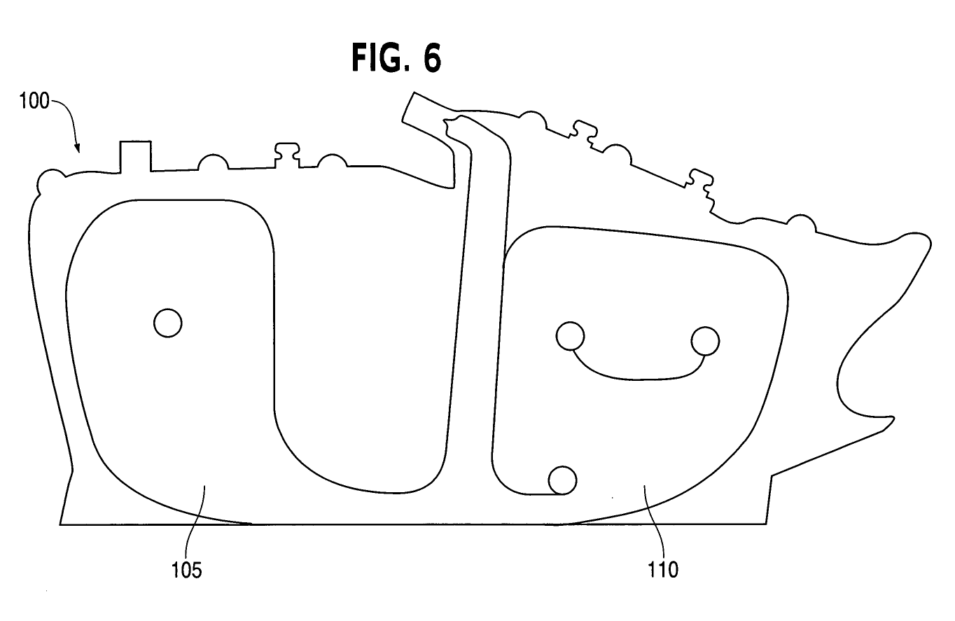

FIGS. 6 shows a side views of a bottom filled side airbag 100 according to an embodiment of the present invention. In the example shown in FIG. 6, the airbag 100 has asymmetrical chambers 105, 110.

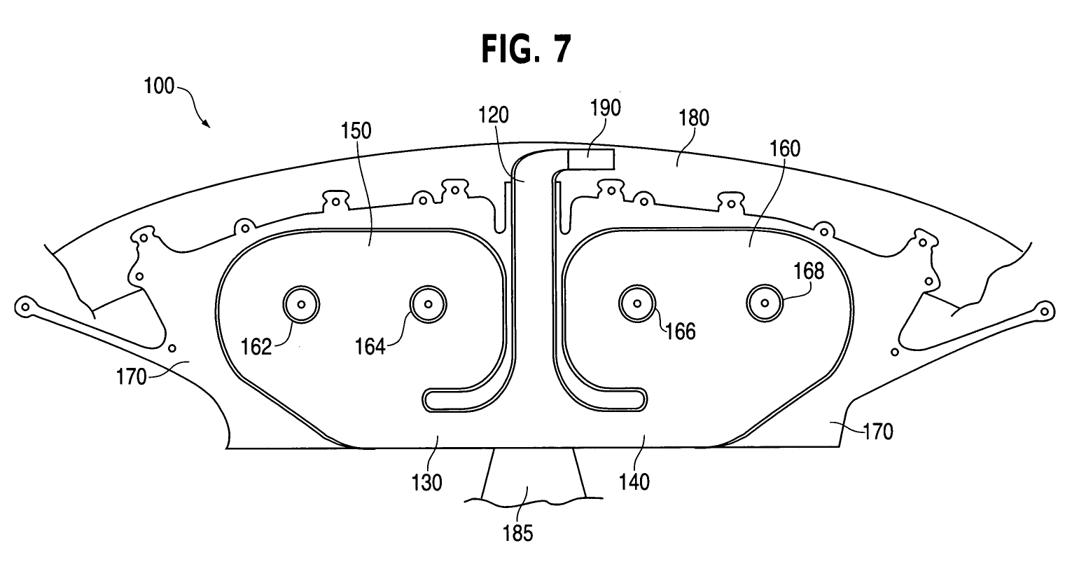

FIG. 7 shows a side view of a bottom filled side airbag 100 according to an embodiment of the present invention in a deployed state. The bottom filled side airbag includes one or more fill channels 120 that direct inflation gas from an inflator 190 to a bottom portion of the airbag. Inflation gas is then directed through one or more passages into one or more fill chambers. In the example shown in FIG. 7, a passage 130 directs inflation gas from fill channel 120 into a forward fill chamber 150 and a passage 140 directs inflation gas into a rear chamber 160. Fill chambers may include circular joints 162, 164, 166, 168. Alternatively, fill chambers may include non-inflatable regions instead of, or in addition to, circular joints. The bottom fill side airbag may include non-inflatable portions 170 outside of the fill chambers.

In the example shown in FIG. 7, the bottom fill side airbag is stored in vehicle headliner 180 before deployment. In the example shown in FIG. 7, the airbag deploys along an interior surface of a vehicle so that middle pillar 185, or “B” pillar, is aligned at the center of the airbag.

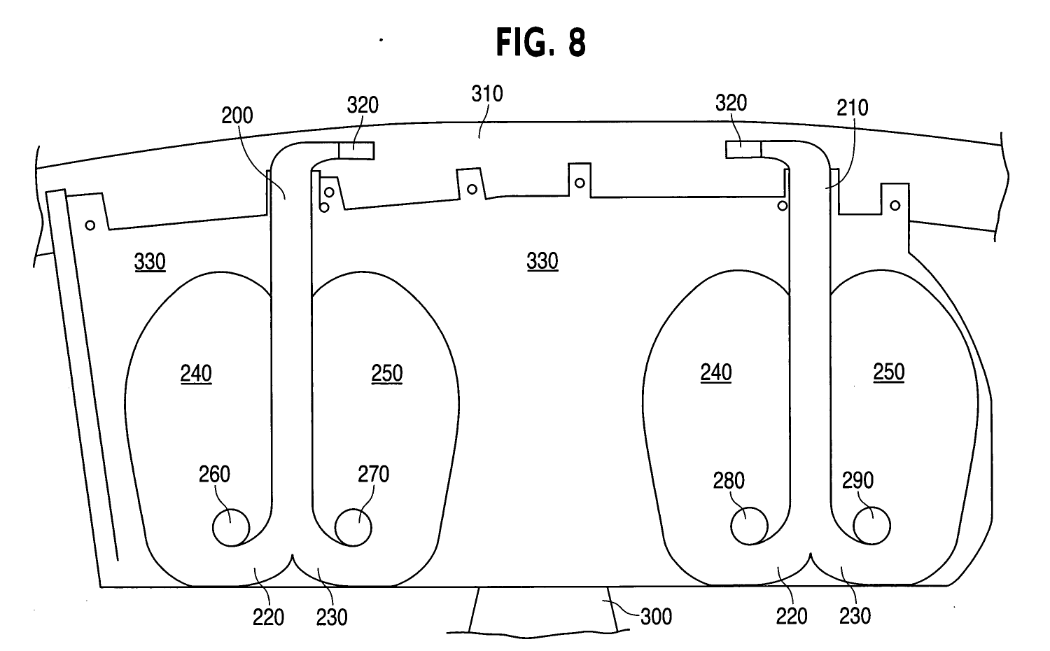

FIG. 8 shows a side view of a bottom fill side airbag according to an embodiment of the present invention. In the example shown in FIG. 8, two fill channels 200, 210 are used to provide inflation gas from an inflator 320 to a bottom portion of an airbag.

Alternatively, two inflators may be provided so that each fill channel has a dedicated inflator. Inflation gas is then directed through one or more fill passages into one or more fill chambers. In the example shown in FIG. 8, a passage 220 supplies inflation gas from a fill channel to a forward fill chamber 240 while a passage 230 provides inflation gas to a rear chamber 250. Fill chambers may include circular joints 260, 270, 280, 290. Alternatively, fill chambers may include non-inflatable regions instead of, or in addition to, circular joints. The bottom fill side airbag may include non-inflatable portions 330 outside of the fill chambers.

The volume of the fill channel is designed so that it is a fraction of the total inflatable volume of the airbag. For example, the ratio of the volume of the fill channel to the total inflatable volume of the airbag may be less than 0.2.

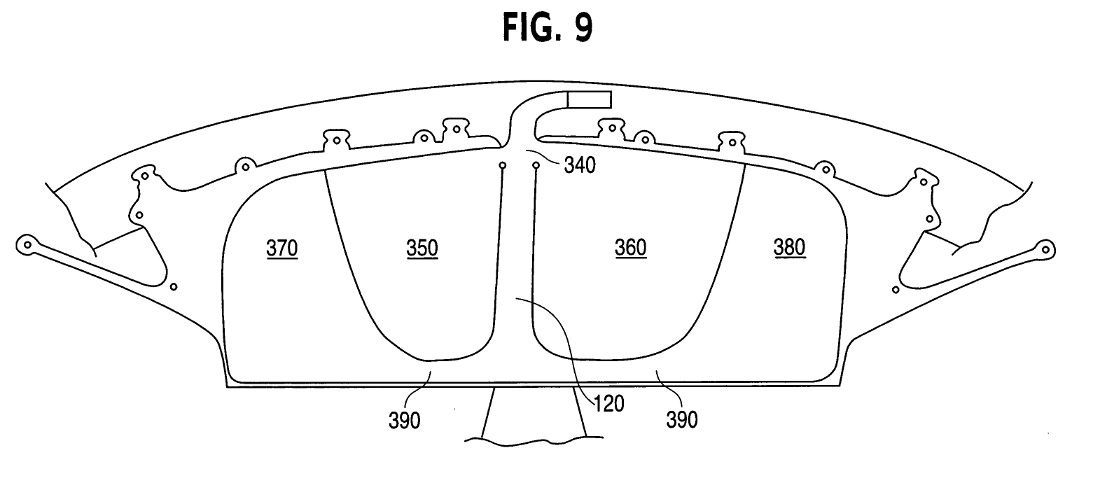

FIG. 9 shows a side view of a bottom fill side airbag according to an embodiment of the present invention. In the example shown in FIG. 9, the fill channel 120 has been designed so it is separated from a top portion of the airbag chambers, creating a separation 340. This allows the fill channel 120 to be designed in different configurations and different volumes. For example, the fill channel 120 may be configured to be tall, short, narrow, and/or wide. In a further example, the fill channel may be designed so that the ratio of the volume of the fill channel to the total inflatable volume of the airbag may be less than 0.2. Inflation gas passes through the fill channel 120 so that a portion of the gas may pass through separation 340 and into chambers 350, 360, while another portion of the gas passes to the bottom of the airbag, through passages 390 and into chamber 370, 380. The configuration of the chambers in FIG. 9 is exemplary and may take different form. For example, chambers 350 and 370 do not have to have complete seams or seals between one another and instead be linked by a common passage or passages. Chambers may also have smaller chambers within each chamber or be configured with different sizes and geometries, as is known in the art.

The bottom fill side airbag of the present invention may have one or a plurality of fill chambers. The airbag may include non-inflating portions in addition to fill chambers.

Channels that direct inflation gas to the bottom of a side airbag may be used to fill one or a plurality of fill chambers. The bottom fill side airbag may be folded and/or rolled to prepare the airbag for containment in a vehicle.

The bottom fill side airbag of the present invention may use one or more inflators per fill channel or one inflator for a plurality of fill channels. Airbag fill channels may be positioned at or near the middle of the length of the airbag or at an end of the airbag.

An inflator may be a non-reactive inflator, reactive inflator, hybrid inflator, or other inflator device known in the art.

In the example shown in FIG. 8, the bottom fill side airbag is stored in vehicle headliner 310 before deployment. In the example shown in FIG. 8, the airbag deploys along an interior surface of a vehicle so that middle pillar 300, or “B” pillar, is aligned at the center of the airbag.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined a set forth in the following claims.

What is claimed is:

1. A side curtain airbag for protecting an occupant of a vehicle, comprising:
at least one fill channel for carrying inflation gas to at least one inflation chamber;
wherein the fill channel is adapted to channel all the inflation gas from a top portion of the airbag to a bottom portion of the airbag, so that the gas enters the chamber from the bottom.

2. The side curtain airbag of claim 1, further comprising:
a passage connecting the fill channel to the chamber.

3. The side curtain airbag of claim 1, further comprising:
at least one non-inflatable region, positioned outside the boundaries of the chamber.

4. The side curtain airbag of claim 1, further comprising:
a plurality of fill channels.

5. The side curtain airbag of claim 1, further comprising:
a plurality of chambers;
a plurality of passages, wherein the passages connect the fill channel to the chambers.

6. The side curtain airbag of claim 1, wherein the fill channel is positioned along the length of the airbag proximate to the middle of the length of the airbag.

7. The side curtain airbag of claim 1, wherein the fill channel is positioned along the length of the airbag proximate to an end of the airbag.

8. The side curtain airbag of claim 1, wherein the ratio of the volume of the fill channel to the total inflatable volume of the airbag is less than 0.2.

9. An airbag system for the side of a vehicle, comprising:
an airbag including at least one fill channel;
wherein the fill channel is adapted to channel all inflation gas from an inflator directly to a bottom portion of the airbag so that the inflation gas is supplied to the airbag chambers from lower portions of the airbag upwardly toward the top of the airbag.

10. The airbag system of claim 9, further comprising:
at least one chamber;
a passage, wherein the passage connects a fill channel to a chamber.

11. The airbag system of claim 9, further comprising:
at least one chamber;
at least one non-inflatable region, wherein the non-inflatable region is positioned outside of the chamber.

12. The airbag system of claim 9, further comprising:
a plurality of fill channels.

13. The airbag system of claim 9, further comprising:
a plurality of chambers;
a plurality of passages, wherein the passages connect the fill channel to the chambers.

14. The airbag system of claim 9, wherein the fill channel is positioned along the length of the airbag proximate to the middle of the length of the airbag.

15. The airbag system of claim 9, wherein the ratio of the volume of the fill channel to the total inflatable volume of the airbag is less than 0.2.

16. The airbag system of claim 9, wherein the longitudinal axis of the fill channel is aligned along the vertical axis of the airbag.

17. A side airbag system for protecting the occupant of a vehicle, comprising:
an inflator;
an airbag, including at least one fill channel;
wherein the fill channel is adapted to channel all the inflation gas from the inflator to a bottom portion of the airbag, causing the bottom portion of the airbag to initially inflate, then subsequently and progressively fill airbag chambers from lower portions of the airbag upward to a top of the airbag.

18. The side airbag system of claim 17, wherein at least one inflator is adapted to provide inflation gas to an individual fill channel.

19. The side airbag system of claim 17, wherein one inflator is adapted to provide inflation gas to a plurality of fill channels.

20. The side airbag system of claim 17, wherein the module is adapted to be contained in a headliner of the vehicle prior to deployment.

21. A side curtain airbag for protecting an occupant of a vehicle, comprising:
an airbag with at least one inflation chamber; and
at least one fill channel for carrying inflation gas to at least one inflation chamber;
wherein the ratio of the volume of the fill channel to the total inflatable volume of the airbag is less than 0.2.
